(19) United States
(12) Patent Application Publication
(10) Pub. No.: US 2017/0029597 A1
(43) Pub. Date: Feb. 2, 2017

(54) STABILISED POLYOLEFIN COMPOSITION

(71) Applicants: SAUDI BASIC INDUSTRIES CORPORATION, Riyadh (SA); SABIC GLOBAL TECHNOLOGIES B.V., Bergen op Zoom (NL)

(72) Inventors: Sarah VAN MIERLOO, Geleen (NL); Carolus Johannes Augustinus ENGELS, Sittard (NL)

(21) Appl. No.: 15/038,900

(22) PCT Filed: Nov. 26, 2014
(86) PCT No.: PCT/EP2014/075610

§ 371 Date: May 24, 2016

(30) Foreign Application Priority Data
Nov. 29, 2013 (EP) 13195110.5

(51) Int. Cl. C08K 5/1545; C08K 5/45

(52) U.S. Cl. CPC C08K 5/1545; C08K 5/45

(57) ABSTRACT

The invention relates to a stabilised polyolefin composition comprising—A. at least a homopolymer or copolymer of ethylene or propylene and—B. natural Vitamin E comprising tocopherol and tocotrienol. The composition may also comprise a component C being at least one compound containing sulfur selected from glutathione, α-lipoic acid and acetyl-cysteine.

The invention relates to a stabilized polyolefin composition.

The stabilization of polyolefin composition is known. Suitable stabilisers are for example synthetic polyphenolic compounds such as tetrakis[methylene-3-(3′,5′)-di-t-butyl-4-hydroxyphenyl)propionate) methane; 1,1,3-tris(2-methyl-4-hydroxy-5-t-butylphenyl)butane; 1,3,5-trimethyl-2,4,6-tris(3,5-di-t-butyl-4-hydroxybenzyl)benzene, bis-(3,3-bis-(4′-hydroxy-3′-t-butylphenyl butanoic acid)-glycol ester; tris(3,5-di-t-butyl-4-hydroxy benzyl)isocyanurate; 1,3,5-tris(4-t-butyl-2,6-dimethyl-3-hydroxy-benzyl)-iso-cyanurate; 5-di-t-butyl-4-hydroxy-hydrocinnamic acid triester with 1,3,5-tris(2-hydroxyethyl)-s-triazine-2,4,6(1H, 3H, 5H)-trione; p-cresol/dicyclopentadiene butylated reaction product; 2,6-bis(2′-bis-hydroxy-3′-t-butyl-5′-methyl-phenyl-4-methyl-phenol).

Also known are synthetic antioxidants such as synthetic obtained tocopherols and their analogues. The structure is represented by the following general formula:

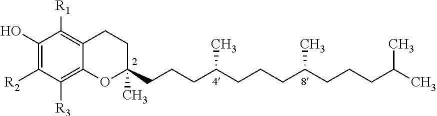

Synthetic Vitamin E (for example Irganox® E-201 supplied by BASF and Novatol™ of ADM) is a racemic mixture of equal amounts of all eight possible stereoisomers of a-tocopherol (RRR, SSS, RRS, RSR, SSR, SRS, SRR, RSS). Synthetic Vitamin E is commonly referred to as dl-α-tocopherol or all-rac-alpha-tocopherol. Only one of the stereoisomers, 12, 5% of the total mixture, is RRR-alpha-tocopherol, the only alpha-tocopherol stereoisomer occurring in natural Vitamin E. The remaining seven stereoisomers in synthetic Vitamin E have different molecular configurations due to the manufacturing process.

Stabilized polyolefin compounds may be processed via for example injection moulding, blow moulding, extrusion moulding, compression moulding or thin-walled injection moulding techniques. The obtained products may be applied in a huge amount of applications for example in food contact packaging applications, biomedical applications, health care applications or pharmaceutical applications.

Most of the synthetic phenolic antioxidants used are strictly regulated by governments because they are suffering from serious limitations. Applied synthetic antioxidants could diffuse into the surrounding medium, could contaminate the food or other human-use products with potentially toxic by-product substances. The toxic nature of the surrounding medium may arise simply because some antioxidants are toxic above a certain level of concentration. This already is an issue in food and water contact applications and medical and pharmaceutical devices. Therefore, the use of such compounds has been related to health risks resulting in stricter regulations over their use in for example food products and food contact applications. This situation has stimulated research for alternative antioxidant sources. With increased consumer concerns about the amount of chemicals in their foods, processors are looking for improved ways to protect their products.

There is a continuous need to provide improved stabilized polyolefin compositions having no dangerous effects when dispersed in the environment and which also fulfill all requirements related to processing and long term heat stabilization.

The invention is characterized in that the polyolefin composition comprises
A. at least a homopolymer or copolymer of ethylene or propylene selected from high density polyethylene, low density polyethylene, linear low density polyethylene or polypropylene
B. natural Vitamin E comprising tocopherol and tocotrienol.

Natural Vitamin E comprising tocopherol and tocotrienol may be for example a mixture comprising RRR alpha-, beta-, gamma-, delta-tocopherol and alpha-, beta-, gamma- and delta-tocotrienol (as described by Al-Malaika S., Goodwin, C., Issenhuth S., Burdick, D., Polym. Degrad. Stab. 1999, 64, 145).

The use of this package, wherein the presence of the combination of tocopherol and tocotrienol is essential, results in the ability to introduce a bio-based antioxidant package with excellent resistance to oxidative degradation.

The use of natural occurring antioxidants bearing a significant higher stabilizing activity in polyolefin compositions compared to synthetic Vitamin E is surprising.

Additional advantages of the stabilizer composition according to the invention are the presence of less discoloration issues of the material and also the obtained improved organoleptic properties.

Furthermore the stabilizer composition according to the invention results in improved processing and long term heat stability.

A suitable example of component B is natural Vitamin E originating from palm oil. Natural Vitamin E is the collective term for a family of fat-soluble chemical substances that are structurally related to RRR alpha-tocopherol.

Natural Vitamin E occurs in eight different forms: four tocopherols, RRR alpha (α)-, RRR beta (β)-, RRR gamma (γ)- and RRR delta (δ)-tocopherol and four tocotrienols, alpha (α)-, beta (β)-, gamma (γ)- and delta (δ)-tocotrienol.

All of these forms consist of a chromanol ring with a long aliphatic side chain, bound to this chromanol ring at the 2 position. Tocotrienols differ from their corresponding tocopherols in that the saturated phytyl side chain is replaced with an unsaturated isoprenoid side chain. The Greek characters refer to the number and the position of the methyl groups at the 5, 7 and 8 positions as displayed in the following FIGURE. Tocopherols have three chiral carbons and the natural materials only have 2R, 4′R, 8′R configuration being RRR α-tocopherol, RRR β-tocopherol, RRR γ-tocopherol and RRR δ-tocopherol.

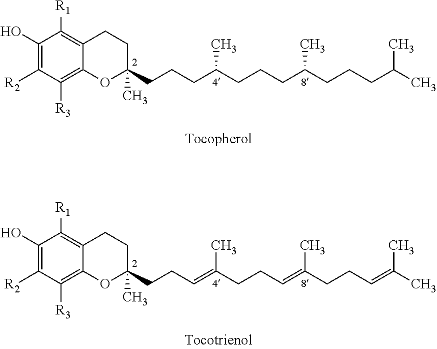

wherein

| Compound | R₁ | R₂ | R₃ |
|---|---|---|---|
| Alpha-tocopherol | CH₃ | CH₃ | CH₃ |
| Alpha-tocotrienol | CH₃ | CH₃ | CH₃ |
| Beta-tocopherol | CH₃ | H | CH₃ |
| Beta-tocotrienol | CH₃ | H | CH₃ |
| Gamma-tocopherol | H | CH₃ | CH₃ |
| Gamma-tocotrienol | H | CH₃ | CH₃ |
| Delta-tocopherol | H | H | CH₃ |
| Delta-tocotrienol | H | H | CH₃ |

The table shows a schematic presentation of the chemical structures of alpha-, beta-, gamma- and delta-tocopherol and tocotrienol. Tocotrienols have the same basic structure as tocopherols, only with the difference of three unsaturated double bonds in the side chain (The EFSA Journal (2008) 6440, 1-34).

According to a preferred embodiment of the invention component B is natural Vitamin E mix extracted from palm fruit with a tocotrienols content relative to the total Vitamin E (tocotrienols plus tocopherols) in the range of 30-95% by weight.

According to a further preferred embodiment of the invention component B is natural Vitamin E mix extracted from palm fruit with a tocotrienols content relative to the total Vitamin E (tocotrienols plus tocopherols) in the range of 50-90% by weight.

The palm fruit is preferably Elaeis Guineesis and/or Elaeis Oleifera.

The relative abundance of the natural occurring Vitamin E homologues (tocopherols and tocotrienols) in a specific preparation depends on the species of plant and the extraction procedure used. Palm oil contains significant quantities of tocotrienols. Other suitable sources of tocotrienols are coconut oil, cereal grains including rice, barley, rye, wheat and nuts. Palm, rice bran, oat and barley contain Vitamin E mostly as the tocotrienols (Ong, 1993; Sheppard et al., 1993; Souci Fachmann Kraut, 2002). The tocopherol and tocotrienol content of some selected plant-derived oils are disclosed in Table 1 of Ong, 1993; Sheppard et al, 1993.

Most vitamins manufactured via a synthetic process have the same molecular configuration as the form that occurs in nature. Consequently, these synthetic vitamins are truly identical to and can be substituted for the natural form with no loss of potency or efficacy. However, this relationship does not hold true for Vitamin E because said eight different structures result from the synthetic manufacture of Vitamin E. In contrast to natural Vitamin E (being a mixture comprising at least alpha-, beta-, gamma-, delta-tocopherol and alpha-, beta-, gamma- and delta-tocotrienol) synthetic Vitamin E is a racemic mixture containing eight different possible stereoisomers of α-tocopherol (RRR, SSS, RRS, RSR, SSR, SRS, SRR, RSS). Synthetic Vitamin E does not contain tocotrienol.

Al-Malaika S., Goodwin, C., Issenhuth S., Burdick, D., Polym. Degrad. Stab. 1999, 64, 145, Azzi et al. (“Vitamin E: non-anti-oxidant roles” in Progress in lipid research 39 (2000) 231-255) and Stone et al. (“Infants discriminate between natural and synthetic Vitamin E” Am J Clin Nutr 2003; 77; 899-906) disclose that natural source and synthetic Vitamin E are not identical.

According to a preferred embodiment of the invention the composition also comprises as component C at least one compound containing sulfur, selected from glutathione, α-lipoic acid and acetyl-cysteïne. This compound acts as secondary antioxidant. This compound results in combination with natural Vitamin E in improved resistance to oxidative degradation.

High density polyethylene may be for example unimodal, bimodal or multimodal high density polyethylene.

Preferred polymers are unimodal HDPE and LLDPE.

The invention is characterized in that the polyolefin composition comprises
A. at least one homopolymer or copolymer of ethylene or propylene selected from high density polyethylene, low density polyethylene, linear low density polyethylene or polypropylene
B. natural Vitamin E comprising at least a tocopherol and tocotrienol
C. at least one compound containing sulfur selected from glutathione, a-lipoic acid and acetyl-cysteIne.

According to a preferred embodiment of the invention the amount of component B ranges between 0.005 and 5% by weight relative to component A and more preferably between 0.05 and 3% by weight relative to component A.

According to a preferred embodiment of the invention the amount of component C ranges between 0.005 and 5% by weight relative to component A and more preferably between 0.05 and 3% by weight relative to component A.

According to a preferred embodiment of the invention the weight ratio B:C ranges between 5:1 and 1:5.

According to a further preferred embodiment of the invention the weight ratio B:C ranges between 5:1 and 1:1.

More preferably the weight ratio B:C ranges between 4:1 and 2:1.

If desired the composition according to the invention may also comprise additional stabilizers and other additives because of the use in specific applications.

The production processes of polyethylenes are summarised in “Handbook of Polyethylene” by Andrew Peacock (2000; Dekker; ISBN 0824795466) at pages 43-66.

The production processes for multimodal polyethylene such as bimodal high density polyethylene are summarised at pages 16-20 of “PE 100 Pipe systems” (edited by Bromstrup; second edition, ISBN 3-8027-2728-2). The production of bimodal high density polyethylene via a low pressure slurry process is described by Alt et al. in “Bimodal polyethylene-Interplay of catalyst and process” (Macromol. Symp. 2001, 163, 135-143).

The composition according to the invention may be used in the production of specific articles. Examples of preferred articles are pipes such as pipes for the transport of drinking water or building and construction, packaging applications such as food packaging applications, flexible packaging and rigid packaging such as caps and closures, biomedical articles for example in-vivo articles, health care articles, pharmaceutical articles, medical articles, sheets (films) and profiles.

The multimodal, for example bimodal, polyethylene composition is suitable for pipe applications for the transport of gas, waste water and drinking water. Pipes have a very good resistance to water however their life is shortened when the pipes come into contact with disinfectants which are often added to water for hygienic reasons. The chlorine used as disinfectant in water degrades most materials including polyethylene (Colin, Aging of polyethylene pipes transporting drinking water disinfected by chlorine dioxide, part I, Chemical aspects; Polymer engineering and Science 49(7); 1429-1437; July 2009). It is known in the art to apply additives for example antioxidants and stabilizers to prevent said degradation. Several types of additives are proposed to protect polymers during processing and to achieve the desired end-use properties. However, appropriate combinations of stabilizers have to be carefully selected, depending on the desired final properties the polymeric article should have.

The present invention also provides a multi modal polyethylene grade for pipe applications for the transportation of chlorine dioxide containing drinking water with improved service lifetime.

The use of synthetic Vitamin E in a polyolefin composition is disclosed in for example WO2012/066126, EP2014704, U.S. Pat. No. 6,277,390 and WO2008006890. These publications do not disclose the use of natural Vitamin E comprising tocopherol and tocotrienol

The invention will now be elucidated by way of the following examples without however being limited thereto.

### EXAMPLES I-IV

The following compounds were used in the examples:
High density polyethylene (HDPE) (SABICO HDPE CC253)(unstabilized)
Synthetic Vitamin E: Irganox E201 (BASF)
(±)-α-Lipoic acid and ascorbic acid 6-palmitate (Sigma-Aldrich)
Natural Vitamin E mix: liquid Natural Vitamin E mix containing 70% mixture of tocotrienols and tocopherols originating from palm fruit with ratio tocotrienol:tocopherol being 4:1.

PRODUCT DESCRIPTION: Gold Tri.E 70 ™
QUANITY: 1 × 1 kg Aluminium Canister
BATCH: SB-DV1306004070

| | | |
|---|---|---|
| Total Tocopherol/Tocotrienol Content | 718.0 | mg/g |
| d-alpha-tocopherol | 168.0 | mg/g |
| d-alpha-tocotrienol | 196.0 | mg/g |
| d-beta-tocotrienol | 24.0 | mg/g |
| d-gamma-tocotrienol | 255.0 | mg/g |
| d-delta-tocotrienol | 75.0 | mg/g |

The high density polyethylene and the various antioxidants were fed to a 15 cc micro-compounder (Xplore) twin-screw extruder having a conical screw and a L/D ratio of 10.

The temperature profile in the zones of the extruder is the following:
Z1=185° C.
Z2=190° C.
Z3=195° C.
   The temperature of the extruder head was maintained at 185° C.

The screw rate was 175 revs per minute so as to have an average residence time in the various zones (z1-z3) of the extruder equal to 180 seconds and the extrusion was carried out under a nitrogen flow. The mixtures obtained from the extruder in the form of “spaghetti”, strands, were cooled down to room temperature by passage in a water cooling bath.

Thin slices have been cut from the obtained strands and were subsequently subjected to thermal analysis by means of Differential Scanning calorimetry (DSC) in order to determine the resistance to oxidation.

Oxidation Induction Time experiments at 200° C. were carried out using a Mettler Toledo DSC 823 Differential Scanning calorimeter (DSC) and operating according to the standard ASTM D3895-1998 “Oxidative-Induction Time of Polyolefins by Differential Scanning calorimetry”. Thin slices cut from strands (1 mg+−0.3 mg) were positioned in open aluminium capsules, heated under a nitrogen flow until the desired temperature of 200 degrees was reached. Once baseline stabilized, the purge flow is changed to oxygen and the heat flow is monitored until the occurrence of the exothermal event characteristic for thermo-oxidative degradation (several hours). The onset of this event is reported as oxidation induction time.

Oxidation Induction Temperature experiments were carried out using a Mettler Toledo DSC 823 Differential Scanning calorimeter (DSC), by heating the material to 320° C. with a heating rate of 10° C./min. Thin slices cut from strands (1 mg+−0.3 mg) were positioned in open aluminium capsules and heated under an oxygen flow until the desired temperature of 320 degrees was reached. The heat flow is continuously monitored on heating and the onset values of the exothermal event characteristic for thermo-oxidative degradation are reported as oxidation induction temperature.

### Example I and Comparative Example A

Comparison between the stabilization performance of natural Vitamin E mix extracted from palm fruit (70% mixture tocopherol and tocotrienol) and synthetic Vitamin-E (Irganox E201) resulted in the following Oxidation Induction Temperatures:

TABLE 1

| | | Concentration in | Oxidation |
|---|---|---|---|
| | | monomodal HDPE | Induction Temperature |
| | | (%) | (° C.) |
| A | Synthetic Vitamin E | 0.5 | 240.5 |
| I | Natural Vitamin E | 0.71 | 244.7 |
| | mix from palm fruit | | |
| A | Synthetic Vitamin E | 1.5 | 246.4 |
| I | Natural Vitamin E | 2.14 | 254.5 |
| | mix from palm fruit | | |

Comparison of Composition I and Comparative Composition A having the same amount of active stabilizer component shows that the natural Vitamin E mix extracted from palm fruit result in improved stabilization at increased temperatures compared to synthetic Vitamin E.

### Example II and Comparative Example B

Comparison between the stabilization performance of natural Vitamin E mix from palm fruit and synthetic Vitamin-E (Irganox E201) resulted in the Oxidation Induction Times as indicated in Table 2:

TABLE 2

| | | Concentration in | Oxidation |
|---|---|---|---|
| | | monomodal HDPE | Induction Time |
| | | (%) | (min) |
| B | Synthetic Vitamin E | 0.5 | 23.8 |
| II | Natural Vitamin E | 0.71 | 44.7 |
| | mix from palm fruit | | |
| B | Synthetic Vitamin E | 1.5 | 35.1 |
| I | Natural Vitamin E | 2.14 | 98.4 |
| | mix from palm fruit | | |

Natural Vitamin E mix extracted from palm fruit results in significant longer oxidation induction times compared to synthetic Vitamin E.

### Example III

The use of Vitamin E mix from palm fruit (70% mixture tocopherol and tocotrienol) combined with natural based secondary antioxidant α-lipoic acid.

TABLE 3

| | Concentration in | Oxidation |
|---|---|---|
| | monomodal HDPE | Induction Temperature |
| | (%) | (° C.) |
| Natural Vitamin E | 2.14 | 254.5 |
| mix from palm fruit | | |
| Natural Vitamin E | 2.14 | 257.6 |
| mix from palm fruit | | |
| lipoic acid | 0.5 | |

Table 3 shows that the use of natural Vitamin E combined with a-lipoic acid improves the Oxygen Induction Temperature (OIT) which results in improved stabilizer performance.

### Example IV

Natural Vitamin E mix from palm fruit (70% mixture tocopherol and tocotrienol) combined with a natural based secondary antioxidant α-lipoic acid.

TABLE 4

| | Concentration in | Oxidation |
|---|---|---|
| | monomodal HDPE | Induction Time |
| | (%) | (min) |
| Natural Vitamin E | 2.14 | 98.4 |
| mix from palm fruit | | |
| Natural Vitamin E | 2.14 | |
| mix from palm fruit | | |
| Lipoic acid | 0.5 | 111.8 |

Table 4 shows that the use of natural Vitamin E combined with α-lipoic acid improves the Oxygen Induction Time (OIT) which results in enhanced stabilizer performance demonstrating synergism between primary and secondary antioxidant.

1. A polyolefin composition comprising
at least one homopolymer or copolymer of ethylene or propylene selected from high density polyethylene, low density polyethylene, linear low density polyethylene, or polypropylene; and
natural Vitamin E comprising a tocopherol and a tocotrienol.

2. A polyolefin composition according to claim 1, wherein the composition further comprises at least one compound containing sulfur selected from glutathione, α-lipoic acid, and acetyl-cysteine.

3. A polyolefin composition according to claim 1, wherein the natural Vitamin E comprises a palm fruit extract comprising a tocotrienol content relative to the total weight of the (tocotrienol plus tocopherol) in the range of 30-95% by weight.

4. A polyolefin composition according to claim 1, wherein the amount of the natural Vitamin E ranges between 0.005 and 5% by weight relative to the at least one homopolymer or copolymer of ethylene or propylene.

5. A polyolefin composition according to claim 2, wherein the amount of at least one compound containing sulfur ranges between 0.005 and 5% by weight relative to the at least one homopolymer or copolymer of ethylene or propylene.

6. An article comprising the polyolefin composition of claim 1.

7. The article of claim 6, wherein the article is a pipe.

8. The article of claim 6, wherein the article is packaging.

9. The article of claim 6, wherein the article is a biomedical or a pharmaceutical article.

10. The article of claim 6, wherein the article is a health care article.

11. The article of claim 6, wherein the article is a pharmaceutical article.

12. The article of claim 6, wherein the article is a sheet or profile.

13. A polyolefin composition comprising
at least one homopolymer or copolymer of ethylene or propylene selected from high density polyethylene, low density polyethylene, linear low density polyethylene, or polypropylene; and
natural Vitamin E comprising a tocopherol and a tocotrienol, wherein
the natural Vitamin E is present in an amount of between 0.005 and 5% by weight relative to the at least one homopolymer or copolymer of ethylene or propylene, and
the natural Vitamin E comprises a palm fruit extract comprising 0-95% by weight of the tocotrienol relative to the total weight of the tocotrienol plus tocopherol.

14. An article comprising the polyolefin composition of claim 13.

15. The article of claim 14, wherein the article is a pipe or packaging.

16. The article of claim 14, wherein the article is a sheet or a profile.

17. The article of claim 14, wherein the article is a biomedical or a pharmaceutical or a healthcare article.

18. A polyolefin composition according to claim 13, wherein the composition further comprises at least one compound containing sulfur selected from glutathione, a-lipoic acid, and acetyl-cysteine, wherein the amount of at least one compound containing sulfur ranges between 0.005 and 5% by weight relative to the at least one homopolymer or copolymer of ethylene or propylene.

19. An article comprising the polyolefin composition of claim 18.
